(19) United States
(12) Patent Application Publication
(10) Pub. No.: US 2015/0138694 A1
(43) Pub. Date: May 21, 2015

(54) METHOD FOR MANUFACTURING ELECTRODE FOR USE IN ELECTRICAL STORAGE DEVICE

(71) Applicant: Funai Electric Co., Ltd., Osaka (JP)

(72) Inventors: Takeshi SHIMOMURA, Isehara-shi (JP); Touru SUMIYA, Tokyo (JP); Masao SUZUKI, Tokyo (JP); Masatoshi ONO, Tsukuba-shi (JP)

(21) Appl. No.: 14/522,724

(22) Filed: Oct. 24, 2014

(30) Foreign Application Priority Data
Nov. 7, 2013 (JP) 2013-230807

(51) Int. Cl. H01G 11/86; H01G 11/48; H01G 11/34; H01G 11/28; H01G 11/82; H01G 11/52; H01G 11/24

(52) U.S. Cl. CPC H01G 11/86; H01G 11/52; H01G 11/48; H01G 11/24; H01G 11/28; H01G 11/82; H01G 11/34
USPC 361/502; 29/25.03; 427/79

(57) ABSTRACT

A method for manufacturing an electrode for use in an electrical storage device includes bringing a porous material into contact with an oxidizing agent, then bringing the porous material into contact with a polymerizable monomer, so that the porous material is modified with an electrically-conductive polymer formed by a polymerization reaction of the polymerizable monomer and the oxidizing agent, and forming, on a surface of a collector, an active material layer containing the porous material modified with the electrically-conductive polymer.

### BACKGROUND OF THE INVENTION

1. Field of the Invention

The present invention relates to a method for manufacturing an electrode for use in an electrical storage device.

2. Description of the Related Art

An electric double-layer capacitor (also called “super capacitor”), which is a kind of electrochemical capacitor, is known in the art as an electrical storage device having high power density and long cycle life and requiring short time for full charge/discharge. Electric double-layer capacitors are installed in a variety of industrial devices, OA appliances, home appliances, and industrial tools, such as smart phones, forklifts, and stop idling vehicles, etc.

However, conventional electric double-layer capacitors are disadvantageous in that their energy density is smaller than that of chemical batteries such as lithium-ion batteries and nickel-hydrogen batteries.

Thus, a redox capacitor is proposed, which is a kind of electrochemical capacitor. This is designed to allow an electrically-conductive polymer such as polyaniline or polypyrrole to undergo oxidation-reduction reaction so that a pseudo-increase in capacitance occurs to increase the energy density.

Specifically, for example, an electrode for use in an electrical storage device is proposed, which is produced using, as an active material, a polyaniline/porous carbon composite obtained by mixing and stirring activated carbon and a polyaniline/toluene dispersion and then drying the mixture so that the toluene is removed (see, for example, JP 2008-072079 A).

It also has been proposed that a carbon material/electrically-conductive polymer composite material is obtained by a process including adding pyrrole to a dispersion solution of carbon material powder and an anionic surfactant, stirring them, and then adding an aqueous ammonium persulfate solution dropwise to the mixture while subjecting the mixture to a polymerization reaction, and that the resulting composite material is used to form an electrode for an electrochemical capacitor such as an electric double-layer capacitor or a redox capacitor, or a rechargeable battery (see, for example, JP 2007-005724 A).

According to the method described in JP 2008-072079 A, the polyaniline/porous carbon composite is obtained by a process including dispersing polyaniline, which has been previously obtained by chemical oxidative polymerization of aniline, in an organic solvent and adding activated carbon to the dispersion. Therefore, the polyaniline/porous carbon composite has the problem of poor durability because in the composite, polyaniline is merely deposited on the surface of activated carbon.

According to JP 2007-005724 A, a composite material of a porous carbon material and an electrically-conductive polymer obtained by chemical oxidative polymerization is used to form a polarizing electrode for an electric double-layer capacitor, and such an electric double-layer capacitor has a problem in that some pores (micropores) of the porous carbon material are clogged with the electrically-conductive polymer formed by polymerization, which reduces the number of “pores” that serve as the most important factor of large surface area contributing to the electric double layer formation, so that the discharge capacity cannot be significantly increased. According to JP 2007-005724 A, this problem should be solved by forming an electrically-conductive polymer film on a carbon material with an average primary particle size of 1,000 nm or less so that the electrically-conductive polymer film can have a significantly increased surface area, or by using a surfactant when the carbon material is dispersed so that a uniform, electrically-conductive, polymer film can be formed on the carbon material.

In fact, when the conventional procedure is used to form the carbon material/electrically-conductive polymer composite material, specifically, for example, when the carbon material/electrically-conductive polymer composite material is produced by bringing the carbon material (porous material) into contact with pyrrole (a polymerizable monomer) and then bringing the carbon material into contact with ammonium persulfate (an oxidizing agent) as described in JP 2007-005724 A, the pores of the porous material are filled with the polymerizable monomer before the porous material is brought into contact with the oxidizing agent. This makes it difficult for the oxidizing agent to reach the inside of the pores of the porous material, so that the electrically-conductive polymer may be insufficiently formed and the polymerizable monomer may remain inside the pores, which may lead to a lower capacitance because the polymerizable monomer is an insulator by itself. In addition, the carbon material/electrically-conductive polymer composite material prepared by the conventional procedure has higher internal resistance because the pores of the porous material are filled with the polymerizable monomer and the electrically-conductive polymer, and the use of the porous material with a large specific surface area is not so effective.

According to JP 2007-005724 A, therefore, the conventional procedure for preparing the carbon material/electrically-conductive polymer composite material should include using a porous carbon material with an average primary particle size of 1,000 nm or less or using a surfactant for dispersing the carbon material so that the composite material can form an electrochemical capacitor or a secondary battery with higher capacitance or better charge/discharge characteristics. However, the use of a porous carbon material with an average primary particle size of 1,000 nm or less or the use of a surfactant for dispersing the carbon material causes problems such as a complicated electrode manufacturing process and an increase in the manufacturing cost.

### SUMMARY OF THE INVENTION

Preferred embodiments of the present invention provide a simple method for manufacturing an electrode with which a high-performance, high-durability, electrical storage device are achieved.

A first aspect of various preferred embodiments of the present invention is directed to a method for manufacturing an electrode for use in an electrical storage device, the method including bringing a porous material into contact with an oxidizing agent and then bringing the porous material into contact with a polymerizable monomer, so that the porous material is modified with an electrically-conductive polymer formed by a polymerization reaction of the polymerizable monomer and the oxidizing agent, and forming, on a surface of a collector, an active material layer containing the porous material modified with the electrically-conductive polymer.

The polymerizable monomer preferably is at least one selected from aniline, pyrrole, and thiophene.

The porous material preferably includes an electrically-conductive carbon material.

According to various preferred embodiments of the present invention, a porous material is modified with an electrically-conductive polymer by a simple process including bringing the porous material into contact with an oxidizing agent and then bringing the porous material into contact with a polymerizable monomer. According to various preferred embodiments of the present invention, therefore, the electrically-conductive polymer is sufficiently formed even inside the pores of the porous material, and a thin film of the electrically-conductive polymer is formed on the surface of the porous material (including the surface of the pores) while the pores of the porous material are prevented from being filled with the polymerizable monomer or the electrically-conductive polymer. This makes it possible to manufacture an electrode with which a high-performance, high-durability, electrical storage device are achieved.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view showing an example of an electrical storage device according to a preferred embodiment of the present invention.

FIG. 2 is a cross-sectional view showing an example of an electrical storage device according to a preferred embodiment of the present invention.

FIGS. 3A and 3B are flow charts showing an example of a method according to a preferred embodiment of the present invention for manufacturing an electrode for use in an electrical storage device.

FIGS. 4A and 4B are graphs showing the results of cycles of charge/discharge test using the capacitors of an Example and Comparative Examples, in which FIG. 4A shows changes in capacitance, and FIG. 4B shows changes in internal resistance.

### DETAILED DESCRIPTION OF THE PREFERRED EMBODIMENTS

Hereinafter, preferred embodiments of the present invention will be described with reference to the drawings. Preferred embodiments of the present invention include electrical storage devices and methods for manufacturing electrodes for use in electrical storage devices. Some preferred embodiments described below have various technically preferred limitations for carrying out the present invention. It will be understood that the preferred embodiments described below and the examples thereof are not intended to limit the scope of the present invention.

First, an electrical storage device according to a preferred embodiment of the present invention will be described. This preferred embodiment provides an electric double-layer capacitor as an example of the electrical storage device. It will be understood that the electrical storage device of the present invention may be of any other type, such as an electrochemical capacitor or a secondary battery, as long as it has an electrode including, as an active material, a composite of a porous material and an electrically-conductive polymer.

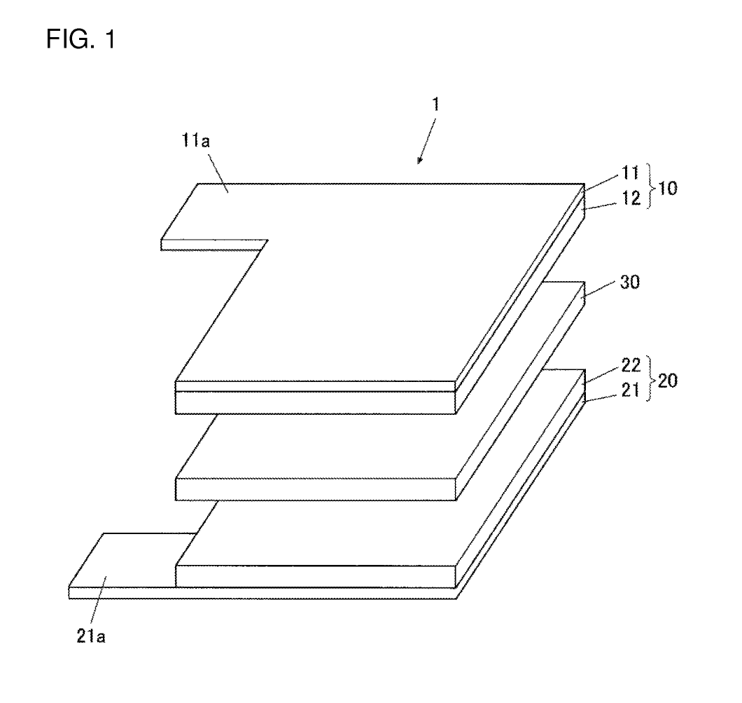

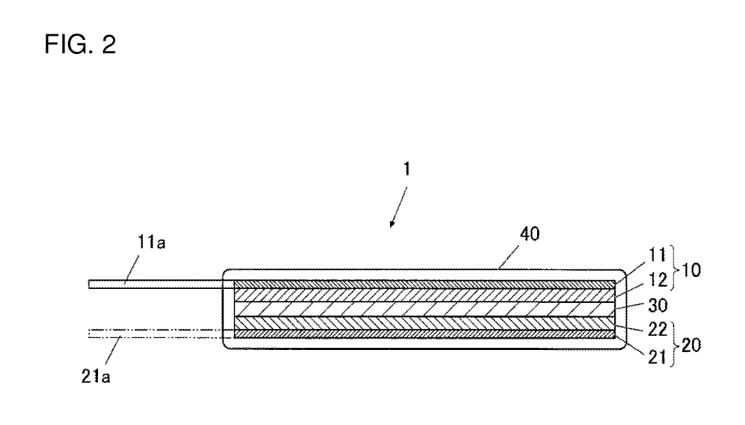

FIG. 1 is an exploded perspective view showing an example of an electrical storage device (an electric double-layer capacitor 1) according to a preferred embodiment of the present invention. FIG. 2 is a cross-sectional view showing an example of an electrical storage device (an electric double-layer capacitor 1) according to a preferred embodiment of the present invention.

As shown in FIGS. 1 and 2, the electric double-layer capacitor 1 is an electrical storage device including a positive electrode collector 11 and a negative electrode collector 21, which are arranged opposite to each other, a positive electrode active material layer 12 provided on one surface (the negative electrode collector 21-side surface) of the positive electrode collector 11, a negative electrode active material layer 22 provided on one surface (the positive electrode collector 11-side surface) of the negative electrode collector 21, a separator 30 disposed between the positive and negative electrode active material layers 12 and 22, and a housing 40 adapted to house these components. For convenience, the housing 40 is not shown in FIG. 1.

A multilayer type may also be provided, including collectors that each have both surfaces coated with positive and negative electrode active material layers 12 and 22, respectively, and are stacked in parallel or series and housed in a package.

The collectors 11 and 21 are configured to electrically connect the active material layers 12 and 22, respectively, to an external circuit. The collectors 11 and 21 are provided with terminals 11a and 21a, respectively, which extend out of the housing 40 and to be connected to an external circuit. The collectors 11 and 21 may be made of any material having characteristics such as (1) high electron conductivity, (2) the ability to be stable inside the capacitor, (3) the ability to be formed with a small volume (small thickness) inside the capacitor, (4) light weight per unit volume (lightness), (5) easy processability, (6) high practical strength, (7) adhesion (mechanical adhesion), and (8) resistance to corrosion or dissolution caused by electrolyte. For example, the collectors 11 and 21 each may be made of a metallic electrode material such as platinum, aluminum, gold, silver, copper, titanium, nickel, iron, or stainless steel, or a non-metallic electrode material such as carbon, electrically-conductive rubber, or electrically-conductive polymer. Alternatively, at least inner surfaces of the housing 40 may be made of a metallic electrode material and/or a non-metallic electrode material, and the active material layers 12 and 22 may be provided on the inner surfaces, respectively. In this case, the housing 40 may be configured to also define and serve as the collectors 11 and 21.

A positive electrode 10 for the electric double-layer capacitor 1 according to a preferred embodiment of the present invention preferably includes the positive electrode collector 11 and the positive electrode active material layer 12 provided on the surface of the positive electrode collector 11. A negative electrode 20 for the electric double-layer capacitor 1 according to a preferred embodiment of the present invention includes the negative electrode collector 21 and the negative electrode active material layer 22 provided on the surface of the negative electrode collector 21.

The active material layers 12 and 22, which are provided on the surfaces of collectors 11 and 21, respectively, define an electric double layer at the interface with an electrolytic solution with which the separator 30 is impregnated. The active material layers 12 and 22 each include an active material, a conductive aid, and a binder resin.

In this preferred embodiment, a porous material is used (by itself) as the active material in the negative electrode active material layer 22, and an electrically-conductive polymer-modified material including a porous material and an electrically-conductive polymer provided to modify the surface of the porous material (including the surface of the pores) is used as the active material in the positive electrode active material layer 12.

The porous material in each of the active material layers 12 and 22 is configured to increase the area of the contact surface with the electrolytic solution, with which the separator 30 is impregnated, and thus to increase the capacitance of the electric double-layer capacitor 1. The porous material may be an electrically-conductive porous material such as activated carbon or an insulating porous material such as silica. The porous material is preferably an electrically-conductive material in view of the use as an electrode material. In view of manufacturing cost and other factors, the electrically-conductive porous material more preferably includes an electrically-conductive carbon material such as activated carbon, graphene, carbon nanotubes, or carbon nanofibers.

When the type and amount of the conductive aids are appropriately selected, an insulating porous material preferably is also advantageously used as the porous material in each of the active material layers 12 and 22.

The positive electrode active material layer 12 may contain a single porous material or two or more different porous materials.

The negative electrode active material layer 22 may also contain a single porous material or two or more different porous materials.

The porous material in the positive electrode active material layer 12 may be the same as or different from the porous material in the negative electrode active material layer 22.

In this preferred embodiment, the surface of the porous material in the positive electrode active material layer 12 preferably is modified with an electrically-conductive polymer capable of undergoing an oxidation-reduction reaction during the charge/discharge of the electric double-layer capacitor 1. This allows the electric double-layer capacitor 1 to have a high capacitance because not only the electric double layer formed on the surface of the porous material with a large specific surface area is effective in increasing the capacitance but also the addition of pseudo-capacitance associated with the oxidation-reduction reaction of the electrically-conductive polymer is effective in increasing the capacitance.

In this preferred embodiment, the positive electrode active material layer 12 preferably contains the electrically-conductive polymer-modified material, but the negative electrode active material layer 22 does not contain such a material. In this regard, at least one of the positive and negative electrode active material layers 12 and 22 preferably contains the electrically-conductive polymer-modified material. Therefore, the positive electrode active material layer 12 may contain the porous material (porous material alone) as an active material, and the negative electrode active material layer 22 may contain the electrically-conductive polymer-modified material as an active material, or both the positive and negative electrode active material layers 12 and 22 may contain the electrically-conductive polymer-modified material as an active material.

The electrically-conductive polymer is configured to cause a pseudo-increase in the capacitance of the electric double-layer capacitor 1 by giving and receiving electrons during the oxidation-reduction reaction.

The electrically-conductive polymer may be a polymer obtained by chemical oxidative polymerization of at least one selected from aniline, pyrrole, and thiophene. Specifically, polyaniline, polypyrrole, or polythiophene may be used as the electrically-conductive polymer, or a copolymer of at least two of aniline, pyrrole, and thiophene may be used as the electrically-conductive polymer. Alternatively, any combination of these polymers may be used.

When the electrically-conductive polymer is synthesized using aniline, pyrrole, or thiophene as a polymerizable monomer, an anionic surfactant, a cationic surfactant, or a neutral surfactant may be added to a polymerizable monomer solution in which the polymerizable monomer is dissolved.

The conductive aid in each of the active material layers 12 and 22 reduces the internal resistance of the electric double-layer capacitor 1. The conductive aid may be, for example, carbon black such as acetylene black, furnace black, channel black, thermal black, or Ketjen black.

The binder resin in each of the active material layers 12 and 22 is configured to bind the active material and the conductive aid, which are mixed together. The binder resin may be, for example, styrene butadiene rubber (SBR), polytetrafluoroethylene (PTFE), polyvinylidene fluoride (PVdF), tetrafluoroethylene-propylene (FEPM) copolymer, an elastomeric binder, or the like. After kneaded by a wet or dry process, the binder resin preferably is applied to form a coating on the collecting electrode (collector).

The separator 30 is disposed between the adjacent positive and negative electrodes 10 and 20. The separator 30 is configured to prevent the positive and negative electrodes 10 and 20 from being in contact with each other in the housing 40 and forming a short circuit. The separator 30 may be made of an insulating material capable of retaining an electrolytic solution. Different insulating materials are preferably used depending on whether the electrolytic solution to be contained in the separator 30 is aqueous or non-aqueous. Specifically, the separator 30 may be, for example, a film of polyolefin, polytetrafluoroethylene (PTFE), polyethylene, cellulose, polyvinylidene fluoride (PVdF), or the like.

The electrolytic solution, with which the separator 30 is impregnated, soaks into the positive and negative electrode active material layers 12 and 22 and defines an electric double layer at the interface.

The electrolytic solution, with which the separator 30 is impregnated, may be aqueous or non-aqueous.

The aqueous electrolytic solution may be an aqueous solution of a supporting electrolyte.

Typical examples of such a supporting electrolyte include, but are not limited to, H₂SO₄, HCl, KCl, NaCl, KOH, NaOH, etc.

The electrolytic solution may contain a single supporting electrolyte or two or more different supporting electrolytes.

The non-aqueous electrolytic solution may be a solution of a supporting electrolyte in a predetermined organic solvent.

Typical examples of such a supporting electrolyte include, but are not limited to, TEABF₄, TEAPF₆, LiPF₆, LiBF₄, LiClO₄, TEABF₄, TEAPF₆, etc.

The predetermined organic solvent may be, for example, ethylene carbonate (EC), ethyl methyl carbonate (EMC), propylene carbonate (PC), diethyl carbonate (DEC), dimethyl carbonate (DMC), or the like.

The housing 40 is configured to house a stack of the collectors 11 and 21, the active material layers 12 and 22, and the separator 30 impregnated with the electrolytic solution. In this structure, the housing 40 is insulated from the collectors 11 and 21.

The housing 40 may be composed of a laminate film material made of aluminum, stainless steel, titanium, nickel, platinum, gold or the like, or a laminate film material made of any alloy thereof.

Next, a non-limiting example of a method according to a preferred embodiment of the present invention for manufacturing an electrode for use in an electrical storage device will be described.

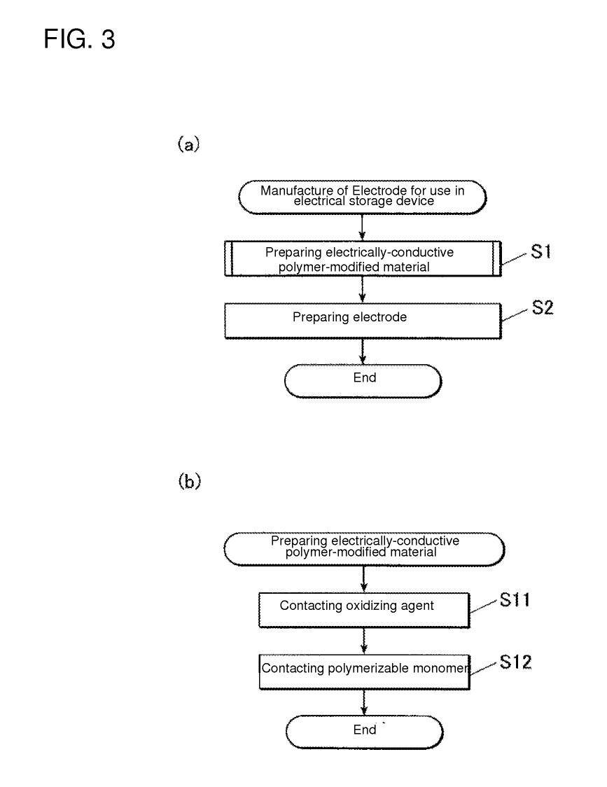

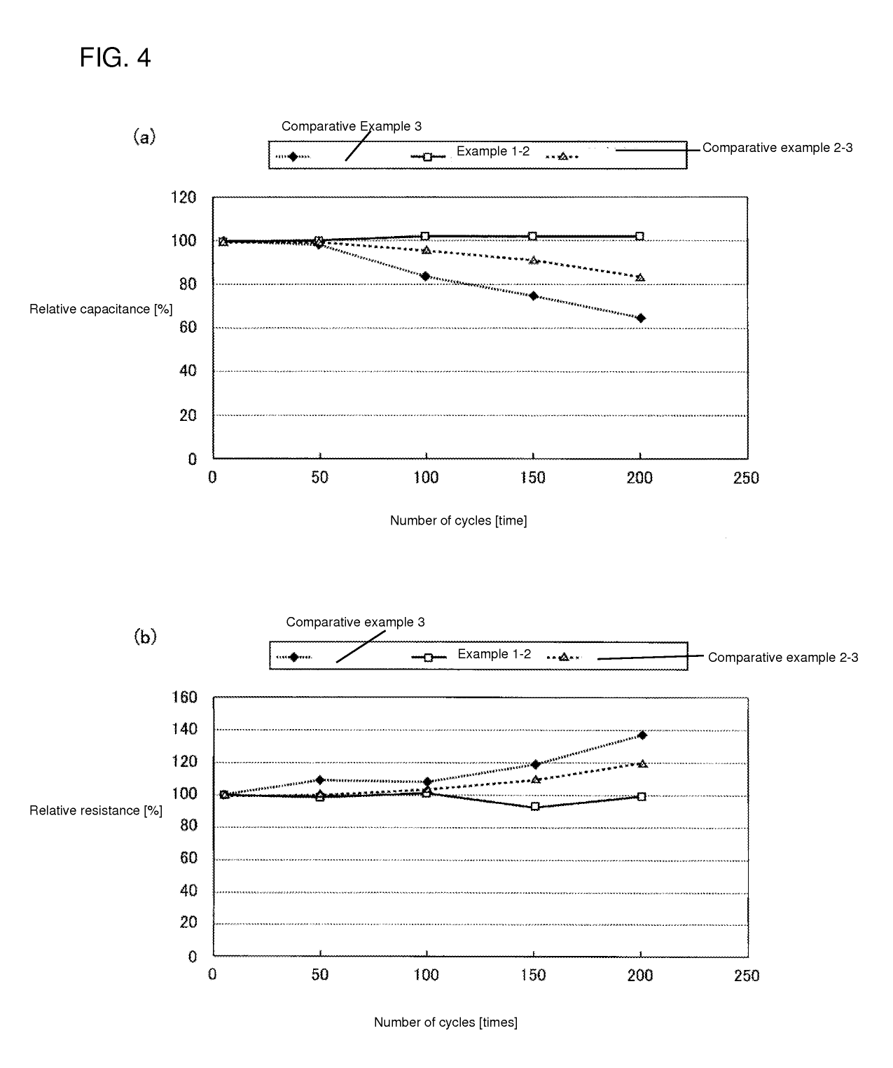

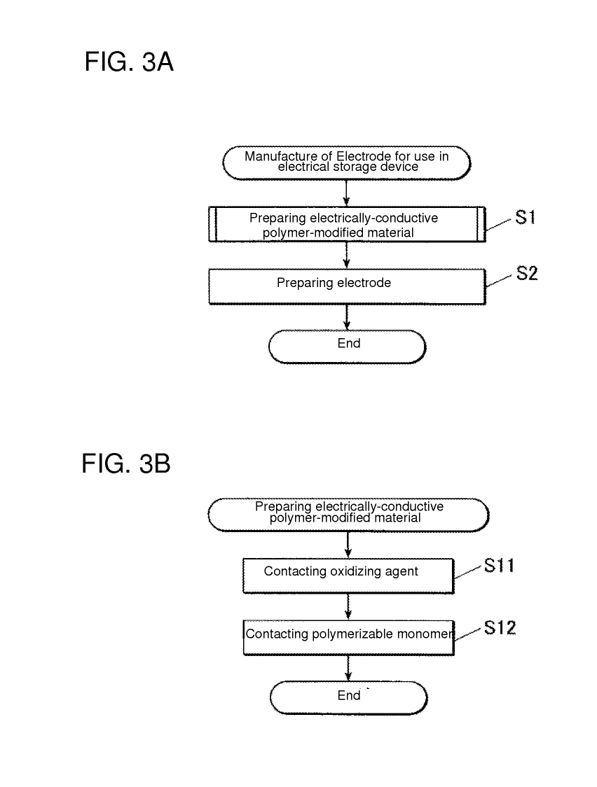

FIGS. 3A and 3B are flow charts showing a non-limiting example of the method according to a preferred embodiment of the present invention for manufacturing an electrode for use in an electrical storage device.

The method according to this preferred embodiment for manufacturing an electrode for use in an electrical storage device includes, as shown in FIG. 3A, preparing an electrically-conductive polymer-modified material (step S1) and preparing an electrode using the prepared electrically-conductive polymer-modified material (step S2).

### <<Step S1>> Preparing Electrically-Conductive Polymer-Modified Material

Preparing an electrically-conductive polymer-modified material includes, as shown in FIG. 3B, contacting an oxidizing agent (step S11) and contacting a polymerizable monomer (step S12).

### <<Step S11>> Contacting Oxidizing Agent

Contacting oxidizing agent includes bringing a porous material (porous material alone) into contact with an oxidizing agent.

Specifically, for example, a solution of the oxidizing agent is prepared, and the porous material is added to the oxidizing agent solution and stirred so that the oxidizing agent is diffused throughout the inside of the pores of the porous material and adsorbed (attached) to the surface of the porous material. Subsequently, if necessary, the product may be washed with water and ethanol and then dried.

In this case, the oxidizing agent may be, for example, ammonium persulfate (ammonium peroxodisulfate).

The porous material may be made of, for example, an electrically-conductive carbon material such as activated carbon, graphene, carbon nanotubes, or carbon nanofibers.

### <<Step S12>> Contacting Polymerizable Monomer

Contacting polymerizable monomer includes bringing a polymerizable monomer into contact with the porous material obtained in contacting oxidizing agent contact (the oxidizing agent-treated porous material).

Specifically, for example, a solution of the polymerizable monomer is prepared, and the porous material obtained in contacting oxidizing agent is added to the polymerizable monomer solution and stirred so that the polymerizable monomer is diffused throughout the inside of the pores of the porous material. The polymerizable monomer is then subjected to chemical oxidative polymerization so that the surface of the porous material is modified with an electrically-conductive polymer that is formed by polymerization reaction of the polymerizable monomer and the oxidizing agent. Subsequently, if necessary, the product may be washed with water and ethanol and then dried.

In this case, the polymerizable monomer may be, for example, at least one selected from aniline, pyrrole, and thiophene.

In this way, an electrically-conductive polymer-modified material is successfully prepared, which is a composite of the porous material and the electrically-conductive polymer.

It will be understood that in preparing electrically-conductive polymer-modified material, for example, if necessary, contacting polymerizable monomer may be followed by doping or de-doping the porous material obtained in the step of contacting polymerizable monomer to convert the electrically-conductive polymer into a doped or de-doped state.

### <<Step S2>> Preparing Electrode

Preparing an electrode includes forming active material layers 12 and 22, which each includes an active material, a conductive aid, and a binder resin, on the surfaces of collectors 11 and 21, respectively, to form electrodes (positive and negative electrodes 10 and 20).

Specifically, in this preferred embodiment, the electrically-conductive polymer-modified material is used as the active material for the positive electrode active material layer 12. Therefore, in the process of forming the positive electrode 10, first, the electrically-conductive polymer-modified material obtained in preparing electrically-conductive polymer-modified material, a conductive aid for the positive electrode active material layer 12, and a binder resin for the positive electrode active material layer 12 are kneaded into a positive electrode active material slurry.

Subsequently, the positive electrode active material slurry is deposited on the positive electrode collector 11 to form the positive electrode active material layer 12 on the surface of the positive electrode collector 11, so that the positive electrode 10 is obtained.

In this preferred embodiment, a porous material alone (a naked porous material without any adsorbed oxidizing agent or any modification with an electrically-conductive polymer) is used as the active material for the negative electrode active material layer 22. Therefore, in the process of forming the negative electrode 20, first, a porous material (porous material alone), a conductive aid for the negative electrode active material layer 22, and a binder resin for the negative electrode active material layer 22 are kneaded into a negative electrode active material slurry.

Subsequently, the negative electrode active material slurry is deposited on the negative electrode collector 21 to form the negative electrode active material layer 22 on the surface of the negative electrode collector 21, so that the negative electrode 20 is obtained.

After preparing electrode, the positive and negative electrodes 10 and 20 obtained in preparing electrode are arranged such that the positive and negative electrode active material layers 12 and 22 are opposed to each other, and the separator 30 impregnated with the electrolytic solution is placed between them to form a main capacitor body.

The main capacitor body is then housed in the housing 40, and the opening of the housing 40 is sealed under reduced pressure. The electric double-layer capacitor 1 is completed in this way.

FIG. 1 shows that the positive and negative electrodes 10 and 20 and the separator 30 of the electric double-layer capacitor 1 preferably are rectangular or substantially rectangular, for example. It will be understood that the positive and negative electrodes 10 and 20 and the separator 30 may have any other suitable shape, such as a circular or substantially circular shape, for example.

Hereinafter, various preferred embodiments of the present invention will be described with specific examples, which however are not intended to limit the present invention.

Activated carbon (a porous material) was brought into contact with ammonium persulfate (an oxidizing agent) and then brought into contact with aniline (a polymerizable monomer) to form an electrically-conductive polymer-modified material. An electrode was formed using the prepared electrically-conductive polymer-modified material, and then used to form an electric double-layer capacitor 1. A charge/discharge test was performed for the measurement and comparison of the capacitance and internal resistance of the electric double-layer capacitor 1.

First, activated carbon (a porous material) was brought into contact with ammonium persulfate (an oxidizing agent) and then brought into contact with aniline (a polymerizable monomer) to form an electrically-conductive polymer-modified material.

Specifically, ammonium persulfate (3 g) was dissolved and stirred in a 1 M hydrochloric acid solution (40 cc) to form an oxidizing agent solution.

Activated carbon (500 mg) was then added to the oxidizing agent solution. The ammonium persulfate was adsorbed (attached) to the surface of the activated carbon by gently stirring the mixture at room temperature for 6 hours, so that an oxidizing agent-treated porous material was obtained.

The oxidizing agent-treated porous material was then separated by filtration while washed with water and ethanol, and dried. The oxidizing agent-treated porous material was then dried at 100° C. for 12 hours.

Aniline (1 cc) and a 1 M hydrochloric acid solution (40 cc) were then mixed and stirred under cooling to form a polymerizable monomer solution.

The dried, oxidizing-agent-treated, porous material was then added to the polymerizable monomer solution. The aniline was subjected to polymerization reaction by gently stirring the mixture for 6 hours in a refrigerator, so that an oxidizing-agent-and-then-monomer-treated porous material was obtained.

The oxidizing-agent-and-then-monomer-treated porous material was separated by filtration while washed with water and ethanol, and dried. The oxidizing-agent-and-then-monomer-treated porous material was then dried at 100° C. for 12 hours.

An aqueous hydrazine solution (2 cc) and methanol (8 cc) were then added to the dried, oxidizing-agent-and-then-monomer-treated, porous material. The mixture was stirred so that the material was de-doped.

The de-doped, oxidizing-agent-and-then-monomer-treated, porous material was then separated by filtration while washed with ethanol, and dried. The de-doped, oxidizing-agent-and-then-monomer-treated, porous material was then dried at 100° C. for 12 hours.

Thus, an electrically-conductive polymer-modified material, specifically, activated carbon whose surface was modified with de-doped polyaniline (hereinafter referred to as “sample 1-1”) was obtained by a procedure according to one of the preferred embodiments of the present invention (making contact with an oxidizing agent and then making contact with a polymerizable monomer).

Electrically-conductive polymer-modified materials were also prepared by the procedure according to one of the preferred embodiments of the present invention using different mixing weight ratios of the polymerizable monomer and the porous material.

Specifically, an electrically-conductive polymer-modified material (hereinafter referred to as “sample 1-2”) was prepared by the same process as for sample 1-1, except that the amount of aniline was 200 μL.

Another electrically-conductive polymer-modified material (hereinafter referred to as “sample 1-3”) was also prepared by the same process as for sample 1-1, except that the amount of aniline was 2 cc.

For comparison, an electrically-conductive polymer-modified material was also prepared by bringing activated carbon (a porous material) into contact with aniline (a polymerizable monomer) and then bringing it into contact with ammonium persulfate (an oxidizing agent).

Specifically, activated carbon (40 mg) was mixed with ethanol (10 cc) and dispersed using an ultrasonic vibrator to form an activated carbon dispersion.

Subsequently, aniline (1 cc) and a 1 M hydrochloric acid solution (40 cc) were mixed, and the activated carbon dispersion was added to the mixture. The aniline was adsorbed (attached) to the surface of the activated carbon by stirring the mixture under cooling, so that a monomer-treated porous material was obtained.

A solution of ammonium persulfate (3 g) in a 1 M hydrochloric acid solution (40 cc) was then poured into a 100 cc beaker. The monomer-treated porous material was added to the solution. The aniline was subjected to polymerization reaction by gently stirring the mixture for 6 hours in a refrigerator, so that a monomer-and-then-oxidizing-agent-treated porous material was obtained.

The monomer-and-then-oxidizing-agent-treated porous material was then separated by filtration while washed with water and ethanol, and dried. The monomer-and-then-oxidizing-agent-treated porous material was then dried at 100° C. for 12 hours.

An aqueous hydrazine solution (2 cc) and methanol (8 cc) were then added to the dried, monomer-and-then-oxidizing-agent-treated, porous material. The mixture was stirred so that the material was de-doped.

The de-doped, monomer-and-then-oxidizing-agent-treated, porous material was then separated by filtration while washed with ethanol, and dried. The de-doped, monomer-and-then-oxidizing-agent-treated, porous material was then dried at 100° C. for 12 hours.

Thus, an electrically-conductive polymer-modified material, specifically, activated carbon whose surface was modified with de-doped polyaniline (hereinafter referred to as “sample 2-1”) was obtained by a conventional procedure (making contact with a polymerizable monomer and then making contact with an oxidizing agent).

Electrically-conductive polymer-modified materials were also prepared by the conventional procedure using different mixing weight ratios of the polymerizable monomer and the porous material.

Specifically, an electrically-conductive polymer-modified material (hereinafter referred to as “sample 2-2”) was prepared by the same process as for sample 2-1, except that the amount of activated carbon was 500 mg.

Another electrically-conductive polymer-modified material (hereinafter referred to as “sample 2-3”) was also prepared by the same process as for sample 2-1, except that the amount of activated carbon was 2 g.

For comparison, free, de-doped polyaniline was prepared, which was neither fixed nor attached onto a porous material.

Specifically, aniline (1 cc) and a 1 M hydrochloric acid solution (40 cc) were mixed and stirred under cooling to form a polymerizable monomer solution.

A solution of ammonium persulfate (3 g) in a 1 M hydrochloric acid solution (40 cc) was then poured into a 100 cc beaker, to which the polymerizable monomer solution was added. The aniline was subjected to polymerization reaction by gently stirring the mixture for 6 hours in a refrigerator, so that a polymer was obtained.

The polymer was then separated by filtration while washed with water and ethanol, and dried. The polymer was then dried at 100° C. for 12 hours.

An aqueous hydrazine solution (2 cc) and methanol (8 cc) were then added to the dried polymer. The mixture was stirred so that the polymer was de-doped.

The de-doped polymer was then separated by filtration while washed with ethanol, and dried. The de-doped polymer was then dried at 100° C. for 12 hours.

Thus, free, de-doped polyaniline (hereinafter referred to as “sample 3”) was obtained.

Using each prepared sample, an electrode was then prepared and used to form an electric double-layer capacitor 1. A charge/discharge test was then performed for the measurement and comparison of the capacitance and internal resistance of the electric double-layer capacitor 1.

Specifically, sample 1-1 was used as an active material for a positive electrode active material layer. Sample 1-1 (40 mg) was mixed with acetylene black (5 mg) as a conductive aid, a dispersion of SBR as a binder resin (corresponding to 2.5 mg SBR (12.5 μL)), and an aqueous solution of carboxymethyl cellulose (CMC) as a binder (corresponding to 2.5 mg CMC (250 μL)). The mixture was kneaded in a mortar to give a positive electrode active material slurry.

The positive electrode active material slurry was then applied to a Pt electrode (including a glass substrate and Pt sputtered thereon) using a Teflon® squeegee. The slurry was air-dried and then dried at 100° C. for 12 hours, so that a positive electrode 10 was obtained.

An activated carbon electrode (namely, an electrode produced using activated carbon alone as an active material) was then prepared as a negative electrode 20. A separator 30 (a 40-μm-thick polyethylene film (040A2 manufactured by Nippon Sheet Glass Co. Ltd.)) impregnated with 1 M TEATF₄/PC was placed between the prepared positive and negative electrodes 10 and 20 to form a capacitor (hereinafter referred to as the “capacitor of Example 1-1”), which was subjected to a charge/discharge test.

Sample 1-2 was also used as an active material for a positive electrode active material layer to form a capacitor (hereinafter referred to as the “capacitor of Example 1-2”). Sample 1-3 was also used as an active material for a positive electrode active material layer to form a capacitor (hereinafter referred to as the “capacitor of Example 1-3”). The activated carbon alone was also used as an active material for a positive electrode active material layer to form a capacitor (hereinafter referred to as the “capacitor of Comparative Example 1”). Sample 2-1 was also used as an active material for a positive electrode active material layer to form a capacitor (hereinafter referred to as the “capacitor of Comparative Example 2-1”). Sample 2-2 was also used as an active material for a positive electrode active material layer to form a capacitor (hereinafter referred to as the “capacitor of Comparative Example 2-2”). Sample 2-3 was also used as an active material for a positive electrode active material layer to form a capacitor (hereinafter referred to as the “capacitor of Comparative Example 2-3”). Sample 3 was also used as an active material for a positive electrode active material layer to form a capacitor (hereinafter referred to as the “capacitor of Comparative Example 3”). Each capacitor was subjected to a charge/discharge test using the same method as for the capacitor of Example 1-1.

The test conditions were as follows. The charge/discharge current, the upper limit voltage, and the lower limit voltage were set at 7 mA/cm², 2.0 V, and 0.0 V, respectively. The constant current method was used in the charge/discharge test. Table 1 shows the capacitances (cell capacitances) and internal resistances determined from the results. It should be noted that since the negative electrode used is an activated carbon electrode, the resulting capacitance values will be, in principle, smaller than twice the capacitance value of the capacitor of Comparative Example 1 (namely, a capacitor having activated carbon electrodes as both the positive and negative electrodes).

In Table 1, the term “relative cell capacitance” refers to the ratio of the capacitance of each capacitor to the capacitance of the capacitor of Comparative Example 1. In Table 1, the term “relative equivalent capacitance (positive electrode)” refers to the ratio of the capacitance of the positive electrode of each capacitor to the capacitance of the positive electrode of the capacitor of Comparative Example 1.

TABLE 1

| | Active material | Cell capacitance determined | Internal resistance determined | | Relative equivalent |
|---|---|---|---|---|---|
| | post electrode/negative | by charge/discharge test | by charge/discharge test | Relative cell | capacitance |
| | electrode) | [F/g] | [Ω/mm2] | capacitance | (positive electrode) |
| Comparative | Activated carbon/ | 20.28 | 7.70 | 1.00 | 1.00 |
| example 1 | Activated carbon | | | | |
| Comparative | Sample2-2/Activated carbon | 1.19 | 26.79 | 0.06 | 0.03 |
| example 2-1 | | | | | |
| Comparative | Sample2-2/Activated carbon | 3.96 | 21.28 | 0.20 | 0.11 |
| example 2-2 | | | | | |
| Comparative | Sample2-3/Activated carbon | 7.08 | 15.48 | 0.35 | 0.21 |
| example 2-3 | | | | | |
| Comparative | Sample3/Activated carbon | 32.10 | 5.66 | 1.58 | 3.79 |
| example 3 | | | | | |
| Example 1-1 | Sample1-1/Activated carbon | 24.20 | 7.80 | 1.19 | 1.48 |
| Example 1-2 | Sample1-2/Activated carbon | 23.90 | 8.43 | 1.18 | 1.43 |
| Example 1-3 | Sample1-3/Activated carbon | 24.29 | 8.68 | 1.20 | 1.49 |

As shown in Table 1, it has been discovered that the capacitor of Comparative Example 3 (specifically, a capacitor produced using polyaniline alone (free, de-doped polyaniline) as an active material for a positive electrode active material layer) has the highest capacitance and the lowest internal resistance.

It has also been discovered that the capacitances of the capacitors of Examples 1-1 to 1-3 (specifically, capacitors produced using an electrically-conductive polymer-modified material prepared by the procedure of the present invention as an active material for an active electrode active material layer) do not reach that of the capacitor of Comparative Example 3, but are 1.18 to 1.20 times that of the capacitor of Comparative Example 1 (specifically, a capacitor produced using activated carbon alone as an active material for a positive electrode active material layer). It has also been discovered that the capacitors of Examples 1-1 to 1-3 have substantially the same capacitance even though they are produced using different mixing weight ratios of the polymerizable monomer and the porous material.

It has also been discovered that the internal resistances of the capacitors of Examples 1-1 to 1-3 do not reach that of the capacitor of Comparative Example 3, but are 1.01 to 1.13 times that of the capacitor of Comparative Example 1. It has also been discovered that the capacitors of Examples 1-1 to 1-3 have substantially the same internal resistance even though they are produced using different mixing weight ratios of the polymerizable monomer and the porous material.

The capacitors of Examples 1-1 to 1-3 have substantially the same capacitance and internal resistance even though they are produced using different mixing weight ratios of the polymerizable monomer and the porous material. This indicates that even without strict control of the mixing weight ratio of the polymerizable monomer and the porous material, electrodes with constant performance can be produced with high reproducibility.

On the other hand, it has been discovered that the capacitances of the capacitors of Comparative Examples 2-1 to 2-3 (specifically, capacitors produced using an electrically-conductive polymer-modified material prepared by a conventional procedure as an active material for a positive electrode active material layer) are 0.06 to 0.35 times that of the capacitor of Comparative Example 1. It has also been discovered that the capacitors of Comparative Examples 2-1 to 2-3, produced using different mixing weight ratios of the polymerizable monomer and the porous material, have different capacitances. Specifically, it has been discovered that when a constant amount of the polymerizable monomer is used, the resulting capacitance decreases with decreasing porous material amount.

In the case of the conventional procedure, specifically, when bringing activated carbon (a porous material) into contact with aniline (a polymerizable monomer) is followed by bringing the activated carbon into contact with ammonium persulfate (an oxidizing agent), the resulting capacitance decreases as the amount of the polymerizable monomer relative to the amount of the porous material decreases. It is therefore conceivable that in the case of the conventional procedure, the pores of the porous material would be filled with the polymerizable monomer before the porous material is brought into contact with the oxidizing agent, which would make it difficult for the oxidizing agent to reach the inside of the pores of the porous material, so that the electrically-conductive polymer may be insufficiently formed inside the pores of the porous material and a relatively large amount of the polymerizable monomer may remain as an insulator, which may lead to a lower capacitance. It is also conceivable that in the case of the conventional procedure, the pores of the porous material would be filled with the polymerizable monomer and the electrically-conductive polymer, so that the formation of an electric double layer on the surface of the porous material with a large specific surface area can be insufficiently effective in increasing capacitance and result in a lower capacitance.

In contrast, in the case of the procedure of various preferred embodiments of the present invention, specifically, when bringing activated carbon (a porous material) into contact with ammonium persulfate (an oxidizing agent) is followed by bringing the activated carbon into contact with aniline (a polymerizable monomer), the resulting capacitance does not change even when the amount of the polymerizable monomer is changed relative to the amount of the porous material. It is therefore conceivable that in the case of the procedure of various procedures of the present invention, the polymerizable monomer reaches the site where the oxidizing agent is adsorbed (attached) to the surface of the porous material, when subjected to polymerization reaction, so that the electrically-conductive polymer is sufficiently formed even inside the pores of the porous material, which would lead to a higher capacitance. It is also conceivable that in the case of the procedure of various preferred embodiments of the present invention, a thin film of the electrically-conductive polymer is formed on the surface of the porous material, and the pores of the porous material are prevented from being filled with the polymerizable monomer or the electrically-conductive polymer, so that the formation of an electric double layer on the surface of the porous material with a large specific surface area is sufficiently effective in increasing capacitance and result in a higher capacitance.

It has also been discovered that the internal resistances of the capacitors of Comparative Examples 2-1 to 2-3 are 2.01 to 3.48 times that of the capacitor of Comparative Example 1. It has also been discovered that the capacitors of Comparative Examples 2-1 to 2-3, produced using different mixing weight ratios of the polymerizable monomer and the porous material, have different internal resistances. Specifically, it has been discovered that when a constant amount of the polymerizable monomer is used, the resulting internal resistance increases with decreasing porous material amount.

In the case of the conventional procedure, the resulting internal resistance increases as the amount of the polymerizable monomer relative to the amount of the porous material increases. It is therefore conceivable that in the case of the conventional procedure, the pores of the porous material would be filled with the polymerizable monomer and the electrically-conductive polymer, so that the internal resistance increases.

In contrast, in the case of the procedure of various preferred embodiments of the present invention, the internal resistance does not change even when the amount of the polymerizable monomer is changed relative to the amount of the porous material. It is therefore conceivable that in the case of the procedure of various preferred embodiments of the present invention, the polymerizable monomer reaches the site where the oxidizing agent is adsorbed (attached) to the surface of the porous material, when subjected to polymerization reaction, so that a thin film of the electrically-conductive polymer is formed on the surface of the porous material and the pores of the porous material are prevented from being filled with the polymerizable monomer or the electrically-conductive polymer, which would lead to a lower internal resistance.

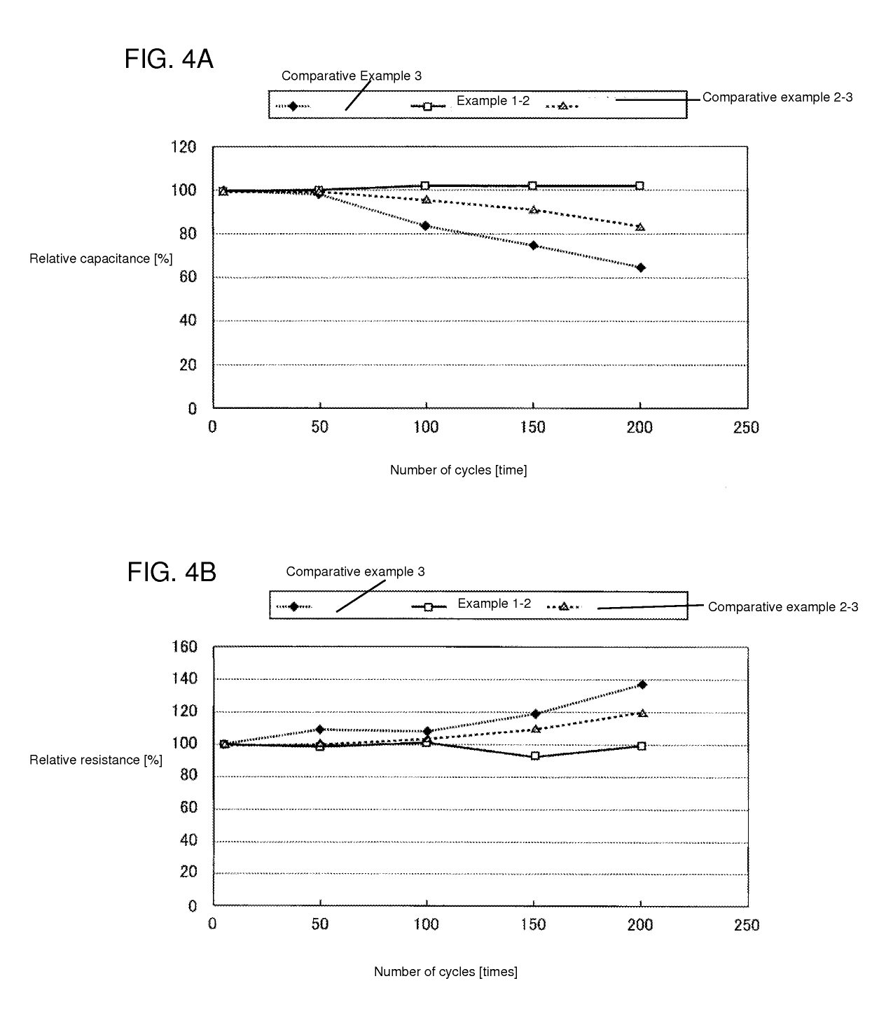

The capacitors of Example 1-2, Comparative Example 2-3, and Comparative Example 3 were each subjected to cycles of charge/discharge test using the constant current method under the following conditions: charge/discharge current, 21.2 mA/cm²; upper limit voltage, 2.5 V; lower limit voltage, 0.0 V. FIGS. 4A and 4B show how the capacitance and internal resistance of the capacitors change during the cycles of charge/discharge test.

As shown in FIGS. 4A and 4B, it has been discovered that the internal resistance of the capacitor of Example 1-2 remains almost unchanged even when 200 cycles of charge/discharge are performed.

On the other hand, it has been discovered that as the number of cycles of charge/discharge increases, the capacitor of Comparative Example 3 decreases in capacitance and increases in internal resistance.

It has also been discovered that as the number of cycles of charge/discharge increases, the capacitor of Comparative Example 2-3 decreases in capacitance and increases in internal resistance, although these changes are smaller than those of the capacitor of Comparative Example 3.

It has therefore been discovered that when the electrically-conductive polymer-modified material prepared by the procedure of various preferred embodiments of the present invention is used as an active material for an electric double-layer capacitor, the electrically-conductive polymer is prevented from being detached from the porous material of the resulting electric double-layer capacitor even after charge/discharge cycles, and the resulting electric double-layer capacitor has higher durability.

The results in Table 1 and FIGS. 4A and 4B show that when the electrically-conductive polymer-modified material prepared by the procedure of various preferred embodiments of the present invention is used as an active material for an electrical storage device, the resulting electrical storage device achieves high performance (specifically, a high capacitance and a low internal resistance) and high durability as compared with those of an electrical storage device produced using a porous material alone as an active material or produced using an electrically-conductive polymer-modified material prepared by the conventional procedure as an active material.

The method of the present preferred embodiment described above for manufacturing an electrode for use in an electrical storage device includes bringing a porous material into contact with an oxidizing agent, then bringing the porous material into contact with a polymerizable monomer, so that the porous material is modified with an electrically-conductive polymer formed by a polymerization reaction of the polymerizable monomer and the oxidizing agent (preparing electrically-conductive polymer-modified material), and forming, on the surface of a collector, an active material layer containing the porous material modified with the electrically-conductive polymer (preparing electrode).

Therefore, the porous material is modified by a simple process that includes bringing the porous material into contact with the oxidizing agent and then bringing the porous material into contact with the polymerizable monomer. In this simple process, the electrically-conductive polymer is sufficiently formed even inside the pores of the porous material, and a thin film of the electrically-conductive polymer is formed on the surface of the porous material while the pores of the porous material are prevented from being filled with the polymerizable monomer or the electrically-conductive polymer, which makes it possible to manufacture an electrode with which a high-performance, high-durability, electrical storage device can be formed.

In the method of this preferred embodiment for manufacturing an electrode for use in an electrical storage device, the polymerizable monomer is preferably at least one selected from aniline, pyrrole, and thiophene.

When at least one selected from aniline, pyrrole, and thiophene is used as the polymerizable monomer, the addition of pseudo-capacitance associated with the oxidation-reduction reaction of the electrically-conductive polymer is sufficiently effective in increasing the capacitance.

In the method of this preferred embodiment for manufacturing an electrode for use in an electrical storage device, the porous material is preferably made of an electrically-conductive carbon material.

When the porous material used is made of an electrically-conductive carbon material, the manufacturing cost can be kept low, and the type or amount of the conductive aid can be selected with greater flexibility.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method for manufacturing an electrode for use in an electrical storage device, the method comprising:
bringing a porous material into contact with an oxidizing agent and then bringing the porous material into contact with a polymerizable monomer, so that the porous material is modified with an electrically-conductive polymer formed by a polymerization reaction of the polymerizable monomer and the oxidizing agent; and
forming, on a surface of a collector, an active material layer containing the porous material modified with the electrically-conductive polymer.

2. The method according to claim 1, wherein the polymerizable monomer is at least one selected from a group consisting of aniline, pyrrole, and thiophene.

3. The method according to claim 1, wherein the porous material comprises an electrically-conductive carbon material.

4. The method according to claim 1, wherein the oxidizing agent is ammonium persulfate or ammonium peroxodisulfate.

5. The method according to claim 1, further comprising doping or de-doping the porous material obtained by contacting the polymerizable monomer to convert the electrically-conductive polymer into a doped state or a de-doped state.

6. The method according to claim 1, wherein the collector on which the active material layer containing the porous material modified with the electrically-conductive polymer is formed is a positive electrode collector including a positive electrode active material layer defined by the active material layer containing the porous material modified with the electrically-conductive polymer.

7. The method according to claim 6, further comprising forming a negative electrode collector by forming a porous material to define a negative electrode active material layer thereof.

8. The method according to claim 7, further comprising arranging the positive electrode collector and the negative electrode collector opposite to each other and placing a separator impregnated with an electrolytic solution between the positive electrode collector and the negative electrode collector to form a main capacitor body.

9. The method according to claim 8, further comprising placing the main capacitor body in a housing and sealing the main capacitor body in the housing under reduced pressure to produce the electrical storage device.

10. The method according to claim 9, wherein the electrical storage device is an electric double-layer capacitor.

11. An electrical storage device comprising:
a positive electrode collector and a negative electrode collector arranged opposite to each other;
a positive electrode active material layer provided on one surface of the positive electrode collector;
a negative electrode active material layer provided on one surface of the negative electrode collector;
a separator disposed between the positive and negative electrode active material layers; and
a housing configured to house the positive electrode collector, the negative electrode collector, the positive electrode active material layer, the negative electrode active material layer and the separator; wherein
at least one of the positive electrode active material layer and the negative electrode active material layer includes an electrically-conductive polymer-modified material including a porous material and an electrically-conductive polymer configured to modify a surface of the porous material.

12. The electrical storage device according to claim 11, wherein the positive electrode active material layer includes the electrically-conductive polymer-modified material as an active material and the negative electrode active material layer includes a porous material as an active material.

13. The electrical storage device according to claim 12, wherein the porous material in each of the positive and negative active material layers is configured to increase an area of a contact surface with an electrolytic solution with which the separator has been impregnated to increase capacitance of the electrical storage device.

14. The electrical storage device according to claim 12, wherein the porous material in each of the positive and negative active material layers is one of a single porous material and at least two different porous materials.

15. The electrical storage device according to claim 11, wherein the negative electrode active material layer includes the electrically-conductive polymer-modified material as an active material and the positive electrode active material layer includes a porous material as an active material.

16. The electrical storage device according to claim 11, wherein both of the positive electrode active material layer and the negative electrode active material layer include the electrically-conductive polymer-modified material as an active material.

17. The electrical storage device according to claim 11, wherein the electrical storage device is an electric double-layer capacitor.

18. An electrical storage device comprising:
a positive electrode collector and a negative electrode collector arranged opposite to each other;
a positive electrode active material layer provided on one surface of the positive electrode collector;
a negative electrode active material layer provided on one surface of the negative electrode collector;
a separator disposed between the positive and negative electrode active material layers; and
a housing configured to house the positive electrode collector, the negative electrode collector, the positive electrode active material layer, the negative electrode active material layer and the separator; wherein
at least one of the positive electrode active material layer and the negative electrode active material layer is formed by the method according to claim 1.

19. The electrical storage device according to claim 18, wherein the polymerizable monomer is at least one selected from a group consisting of aniline, pyrrole, and thiophene.

20. The electrical storage device according to claim 18, wherein the porous material comprises an electrically-conductive carbon material.
